(19) United States
(12) Patent Application Publication
(10) Pub. No.: US 2026/0225766 A1
(43) Pub. Date: Aug. 6, 2026

(54) CONTAINER CASE

(71) Applicant: NIAGARA BOTTLING, LLC, Diamond Bar, CA (US)

(72) Inventors: Mark Doherty, Aliso Viejo, CA (US); Luis Contreras, San Bernardino, CA (US); Fabiola Iniguez Franco, Glendora, CA (US); Sudheer Bandla, Ontario, CA (US); Autumn Lopez-Esce, Pomona, CA (US)

(21) Appl. No.: 19/635,491

(22) Filed: Mar. 31, 2026

Related U.S. Application Data
(63) Continuation of application No. 17/578,187, filed on Jan. 18, 2022, now abandoned.
(60) Provisional application No. 63/138,710, filed on Jan. 18, 2021.

(51) Int. Cl. B65D 23/08; B65C 3/06; B65D 25/56

(52) U.S. Cl. CPC B65D 23/0878; B65D 25/56; B65C 3/065

(57) ABSTRACT

A container case includes a plurality of containers wrapped in a shrink film. The shrink film includes an open end having a rim that defines an opening and a closing component in the form of a first portion of the shrink film having a releasable end. The closing component is configured to one of 1) adhere to or 2) engage, a second portion of the shrink film to thereby reduce an area of the opening.

### CROSS-REFERENCE TO RELATED APPLICATIONS

This application is a continuation of and claims priority to U.S. application Ser. No. 17/578,187, filed Jan. 18, 2022, which claims priority to U.S. Provisional Application No. 63/138,710, filed Jan. 18, 2021, the entire contents of each of which are hereby incorporated by reference.

### FIELD OF THE DISCLOSURE

The present invention relates to recyclable containers.

### BACKGROUND

Consumable liquid drinking products are often packaged in containers made from plastics such as polyethylene (PE), polyethylene terephthalate (PET), polypropylene (PP), polyvinyl chloride (PVC), and the like. The containers can be arranged in groups and wrapped in a shrink film to form a container case for distribution. The shrink film can likewise be made from a recyclable plastic such as PE so that the container case, including the containers and the shrink film, as well as any cardboard base, are recyclable.

### SUMMARY

The present disclosure provides, in one aspect, a container case including a plurality of containers wrapped in a shrink film. The shrink film includes a first open end having a first rim that defines a first opening, and a second open end located opposite the first open end, the second open end having a second rim that defines a second opening. The container case also includes a closing component coupled to the shrink film. The closing component includes at least a portion thereof configured for uncoupling from one portion of the shrink film and recoupling to another portion of the shrink film to thereby reduce an area of the first opening.

The present disclosure provides, in another aspect, a method of manufacturing a container case. The method includes arranging a plurality of containers into a container matrix, wrapping the container matrix with a shrink film in an expanded state, contracting the shrink film about the container matrix to form a container case, and coupling a closing component to the shrink film. At least a portion of the closing component is configured to be uncoupled from one portion of the shrink film and re-adhered to another portion of the shrink film to thereby reduce an area of an opening formed in the shrink film.

The present disclosure provides, in another aspect, a method of recovering a container case for recycling by a recycling facility. The method includes providing the container case, wherein the container case includes a plurality of containers wrapped in a shrink film and a closing component coupled to the shrink film, at least a portion of the closing component is configured to be uncoupled from one portion of the shrink film and re-adhered to another portion of the shrink film to thereby reduce an area of an opening formed in the shrink film. The method further includes providing instructions to return the plurality of containers to the shrink film in response to the plurality of containers being removed from the shrink film, providing instructions to close the opening via the closing component to secure the containers within the shrink film, and providing instructions to ship the container case to the recycling facility.

Other aspects of the disclosure will become apparent by consideration of the detailed description and accompanying drawings.

### BRIEF DESCRIPTION OF THE DRAWINGS

FIGS. 1 and 2 are each perspective views of a container case including a plurality of containers wrapped in a shrink film.

FIG. 3 is a perspective view of the container case with a closing component coupled to the shrink film.

FIG. 4 is a perspective view of the container case with the containers removed from the shrink film.

FIGS. 5 and 6 are perspective views illustrating operation of the closing component.

FIG. 7 is a perspective view of the container case with the containers placed back inside of the shrink film.

FIGS. 8 and 9 are perspective views illustrating operation of a closing component according to another embodiment.

FIGS. 10 and 11 are perspective views illustrating operation of a closing component according to another embodiment.

FIGS. 12 and 13 are perspective views illustrating operation of a closing component according to another embodiment.

FIG. 14 is a perspective view illustrating a closing component according to another embodiment.

FIG. 15 is a perspective view illustrating a closing component according to another embodiment.

FIG. 16 is a perspective view illustrating a closing component according to another embodiment.

FIG. 17 is a perspective view illustrating a closing component according to another embodiment.

FIG. 18 is a perspective view illustrating a closing component according to another embodiment.

FIG. 19 is a perspective view illustrating a closing component according to another embodiment.

FIGS. 20A-20C are perspective views illustrating a closing component according to another embodiment.

FIGS. 21A-21C are perspective views illustrating a closing component according to another embodiment.

FIG. 22 is a flow chart illustrating a method for converting the shrink film to a bag for collecting and transporting the containers after use.

FIG. 23 is a flow chart illustrating a method of assembling the container case.

FIG. 24 is a flow chart illustrating a method of recovering containers for recycling.

FIG. 25 is a flow chart illustrating a decentralized method of recovering containers for recycling.

Before any embodiments of the disclosure are explained in detail, it is to be understood that the disclosure is not limited in its application to the details of construction and the arrangement of components set forth in the following description or illustrated in the following drawings. The disclosure is capable of supporting other embodiments and of being practiced or of being carried out in various ways.

### DETAILED DESCRIPTION

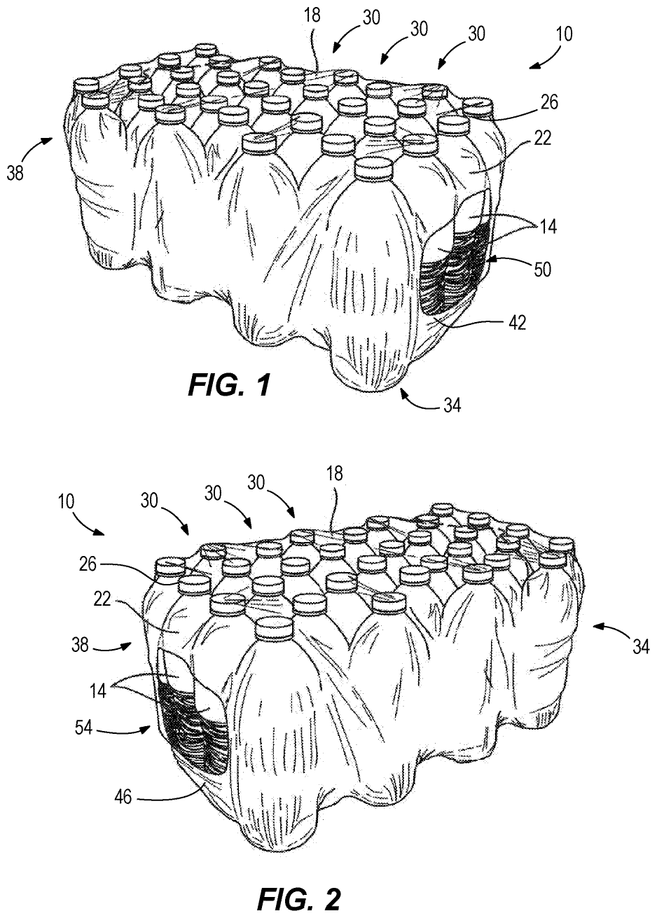

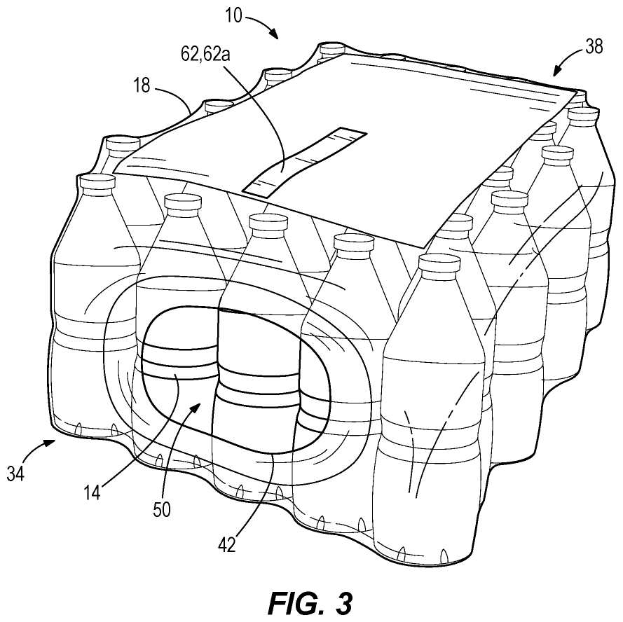

FIGS. 1 and 2 illustrate a shrink-wrapped container case 10 including a plurality of containers 14 wrapped in a shrink film 18. The containers 14 can be configured to store a liquid product (e.g., a consumable liquid product), such as water, juice, carbonated liquids, or other beverages. Each container 14 includes a bottle 22 and a cap 26 that removably couples to a neck of the bottle 22 to enclose a volume of space within the container 14 for storing the liquid product. In the illustrated embodiments, the containers 14 are arranged into a matrix of generally parallel rows 30 of the containers 14, with each pair of two adjacent rows 30 being staggered relative to each other to minimize any empty space therebetween. The shrink film 18 is tightly wrapped or form-fitted about the matrix of the containers 14 to secure and hold the containers 14 within the matrix arrangement. Referring to FIGS. 1 and 2, the container case 10 includes six rows 30 with four containers per row for a total of twenty-four containers. In the embodiments shown in FIGS. 3-13, the container case 10 includes eight rows 30 with five containers per row for a total of forty containers. Other arrangements and numbers of containers within a container case are also contemplated (e.g., to accommodate containers of differing shapes or of differing sizes, etc.), and the disclosure is not limiting with respect to the arrangement or number of containers included in a container case.

To facilitate recycling of the container case 10, the shrink film 18 and the containers 14 (including the bottles 22 and the caps 26) are all constructed from compatible recyclable plastic materials. This allows a consumer to recycle the container case 10 in its entirety without the need for sorting or separating its constituent components. For example, each of the components of the container case 10 can be made from, e.g., polyethylene (PE), polyethylene terephthalate (PET), polypropylene (PP), polyvinyl chloride (PVC), and the like to allow for recycling compatibility. More specifically, the shrink film 18 can be made from, e.g., low-density polyethylene (LDPE), the bottle 22 can be made from, e.g., PET, and the cap 26 can be made from, e.g., high-density polyethylene (HDPE). Other plastic materials are also contemplated, provided that they are compatible recyclable materials (i.e., they may be recycled together without being separated). In addition, the containers 14 and the shrink film 18 may include additional components (e.g., separate labels, etc.; not shown), which can likewise be made from compatible recyclable materials to facilitate recycling after use without having to be separated out or sorted from the rest of the container case 10.

The shrink film 18 has a generally tubular shape and includes a first open end 34 and a second open end 38 opposite the first open end 34. The first open end 34 includes a first periphery or rim 42 that partially covers an outermost row 30 of the containers 14 proximate the first open end 34, and the second open end 38 likewise includes a second periphery or rim 46 that partially covers an opposite outermost row 30 of the containers 14 proximate the second open end 38. The first rim 42 defines a first opening or first bull's eye 50 of the applied shrink film 18 at the first open end 34, and the second rim 46 defines a second opening or second bull's eye 54 of the applied shrink film 18 at the second open end 38. To remove a container 14 from the container case 10, the shrink film 18 can be stretched or torn at either rim 42, 46 to expand the corresponding bull's eye 50, 54 until the container 14 can be removed.

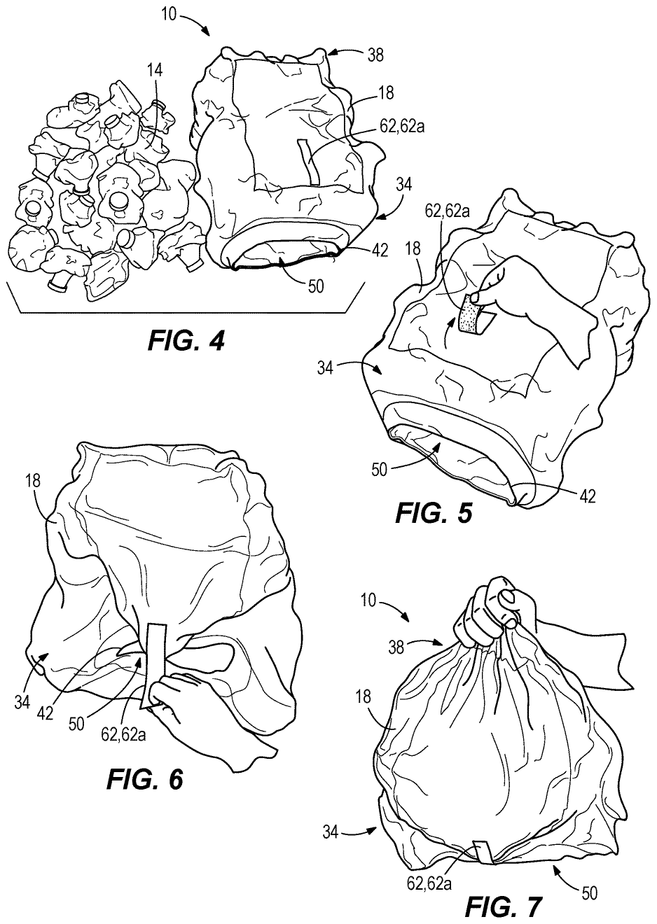

During use, the containers 14 are removed from the shrink film 18 and the contents are consumed such that the container is spent. Once the containers 14 have been removed (FIG. 4), the shrink film 18 can be converted to a receptacle or bag 58 (FIG. 7) for collecting and retaining the spent containers 14. This allows the container case 10 to be easily and efficiently transformed after use and thereafter transported to a recycling destination.

FIGS. 3-13 illustrate embodiments of a closing component 62 provided with the container case 10 and operable to at least partially close or reduce an open area of at least one of the two bull's eyes 50, 54 of the shrink film 18 after the containers 14 have been removed therefrom. For purposes of this disclosure, the open area of the bull's eye can be defined as an area of the open space circumscribed by the rim of the bull's eye and unobstructed by the closing component 62. The closing component 62 can be constructed or formed from a recyclable plastic material (e.g., PE plastic) that is compatible for recycling with the materials of the container case 10 and does not need to be sorted therefrom, and can be formed as, e.g., a strip, a sticker, a cover, a sheet, an overlay, and the like. When one of the bull's eyes 50, 54 is partially or fully closed by the closing component 62, the consumer can place spent containers 14 (one or more of which may be crushed) back inside the converted shrink film 18 (converted to the bag 58) through the remaining open bull's eye 50, 54, and stored and transported therein. The closing component 62 sufficiently reduces an open area of the at least partially closed bull's eye to block, impede, or prevent the spent containers 14 from passing therethrough. For simplicity, the following description will hereafter refer to the at least partially closed bull's eye as the first bull's eye 50 and to the remaining open bull's eye as the second bull's eye 54, although it should be understood that the arrangement may be reversed.

With reference to FIGS. 3-7, in one embodiment, the closing component 62 is in the form of an elongated strip 62a of plastic material (e.g., PE plastic) compatible for recycling with the container case 10. The elongated strip 62a is adhered to the shrink film 18 on a top surface thereof at a location adjacent the first bull's eye 50. In other embodiments, the closing component 62 can include other shapes or forms (described further below) and can alternatively be coupled to other regions of the container case 10, such as to the bottom or the side surfaces of the shrink film 18 or to one or more of the containers 14 themselves, and can be located adjacent the second bull's eye 54, at an intermediate position between the bull's eyes 50, 54, etc. In the illustrated embodiment, the elongated strip 62a is adhered directly to the shrink film 18 via a layer of re-adherable adhesive that allows at least a portion of the elongated strip 62a to be peeled away from the shrink film 18 (FIG. 5) and then re-adhered to a different portion of the shrink film 18 so as to at least partially close the first bull's eye 50 (FIG. 6). The adhesive is likewise compatible for recycling with each of the materials forming the container case 10, including the containers 14, the shrink film 18, the closing component 62, etc. Alternatively, in some embodiments the elongated strip can include a base layer (not shown) fixedly or permanently adhered to the shrink film 18, and a top layer (not shown) removably adhered to the base layer. In such embodiments, only the top layer of the elongated strip is peeled back from the base layer and then adhered to the shrink film 18 in the manner described herein. In the same or other embodiments, two or more different adhesives may be used to couple the elongated strip 62a to the shrink film 18. More specifically, a first, more robust adhesive can secure one portion of the elongated strip 62a to the shrink film 18 in a non-removable manner, and a second, re-adherable adhesive can removably adhere a removable portion of the elongated strip 62a to the shrink film 18. Moreover, the closing component 62 can be provided as two or more elongated strips 62a. In further embodiments, the closing component 62 can include a lattice structure of two or more connected elongated strips (not shown).

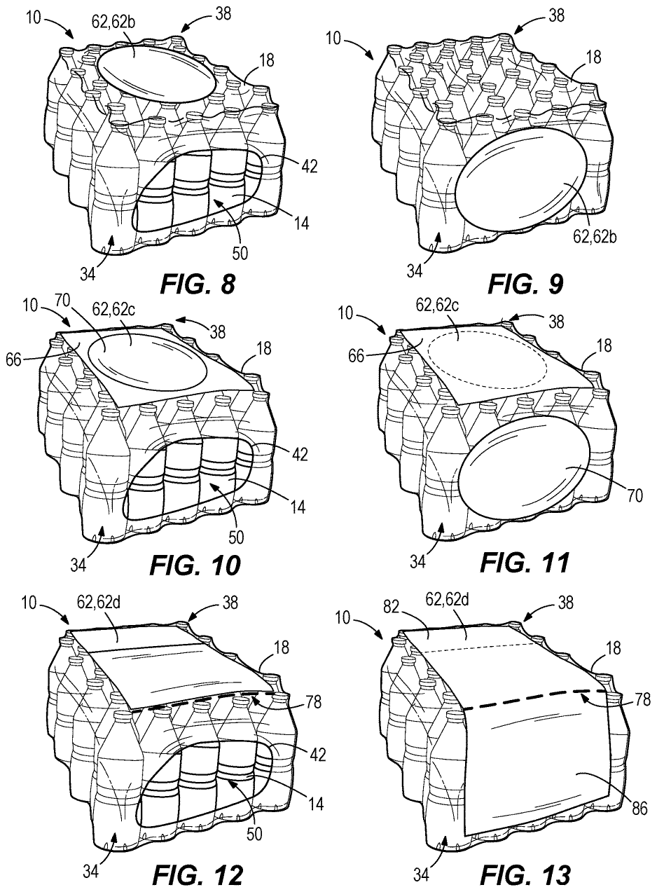

FIGS. 8 and 9 illustrate another embodiment of the closing component 62 in the form of an annular sticker 62b of plastic material (e.g., PE plastic) that is compatible for recycling with the container case 10. The annular sticker 62b is adhered to the shrink film 18 on a top surface thereof between the first and second bull's eyes 50, 54. The annular sticker 62b can have a shape corresponding to the shape of the first bull's eye 50, and can have an area larger than the area of the first bull's eye 50 so that the annular sticker 62b completely closes the first bull's eye 50 when adhered to the first rim 42 of the shrink film 18. Advantageously, the annular sticker 62b can be placed over the first bull's eye 50 before the containers 14 are initially removed from the shrink film 18, which may encourage the user to preserve the first bull's eye 50 and to place the used containers 14 back into the converted shrink film 18. In some embodiments, a re-adherable adhesive can be provided only at a peripheral region of the annular sticker 62b, i.e., the region that engages the first rim 42 when the annular sticker 62b is placed over the first bull's eye 50. This prevents the annular sticker 62b from sticking to the containers 14 if the annular sticker 62b is positioned to close the first bull's eye 50 prior to the containers 14 initially being removed.

FIGS. 10 and 11 illustrate another embodiment of the closing component 62 provided as a layered sticker 62c including a base layer 66 and a removable layer 70. A first, more robust adhesive can secure the base layer 66 to the shrink film 18 in a non-removable manner, and a second, re-adherable adhesive can removably adhere the removable layer 70 to the base layer 66. The removable layer 70 can otherwise be similar to the annular sticker 62b or to the elongated strip 62a described above and operate similarly. Providing the layered sticker 62c with the base and removable layers 66, 70 can decrease the likelihood that the user compromises the shrink film 18 (e.g., by excessive tearing) while removing and repositioning the closing component 62.

FIGS. 12 and 13 illustrate another embodiment of the closing component 62 provided as a folded layer 62d that folds against itself along a fold line 78. The fold line 78 is located proximate the first bull's eye 50 and divides the folded layer 62d between a fixed portion 82 adhered to the shrink film 18 and a movable portion 86 that can be peeled away from the fixed portion 82. To operate the folded layer 62d, the movable portion 86 is peeled away from the fixed portion 82, pivoted about the fold line 78, and adhered to the first rim 42 to at least partially close the first bull's eye 50. In this regard, an adhesive layer can be provided on portions of the movable portion 86 or on portions of the first rim 42 to adhere the moveable portion to the first rim 42.

Each of the closing components 62 described herein can include markings such as text, images, indicia, digital watermarks (visible or non-visible to the human eye), and the like that can instruct the user or consumer on how to manipulate the closing component 62 to convert the shrink film 18 into the bag 58. Additionally or alternatively, such markings can be provided on the shrink film 18 itself, on the containers 14, or on other components of the container case 10.

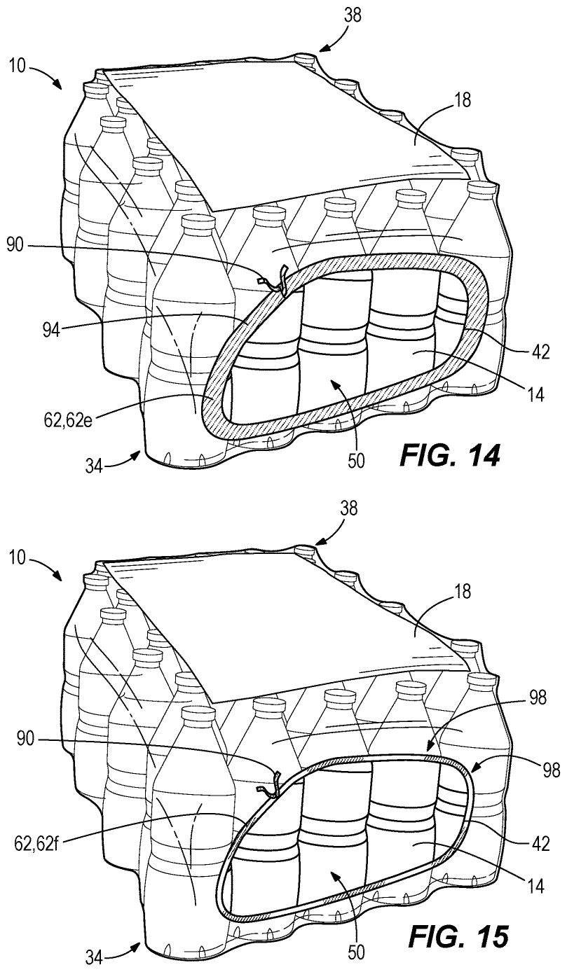

FIG. 14 illustrates another embodiment of the closing component 62 provided as a pull string assembly 62e including a pull string 90 slidably received within a wrapper 94. The wrapper 94 can include two stacked layers or sheets of recyclable material (e.g., such as PE), and the pull string 90 can be sandwiched between the two layers with the distal ends of the pull string 90 protruding out from the wrapper 94 (e.g., through a slit in the wrapper 94) so as to be grasped and pulled by the user. The pull string assembly 62e can be coupled to the shrink film 18 about the first bull's eye 50 (e.g., via adhesive). In operation, the two ends of the pull string 90 are grasped and pulled away from each other so that the pull string 90 slides out of the wrapper 94 through the slit, causing the wrapper 94 to contract or cinch and reduce the open area of the first bull's eye 50.

FIG. 15 illustrates another embodiment of the closing component 62 provided as an alternative pull string assembly 62f that is similar to the pull string assembly 62e shown in FIG. 14, but with the pull string 90 incorporated into the shrink film 18 itself rather than provided inside a separate wrapper. Specifically, the shrink film 18 can include a series of apertures or slits 98 provided at intervals about the first bull's eye 50 proximate the first rim 42. The pull string 90 can extend through each of the slits 98 such that the pull string 90 is woven into the shrink film 18 itself about the first bull's eye 50. In operation, the two ends of the pull string 90 are grasped and pulled away from each other so that the pull string 90 slides through the slits 98, causing the shrink film 18 to contract and reduce the open area of the first bull's eye 50.

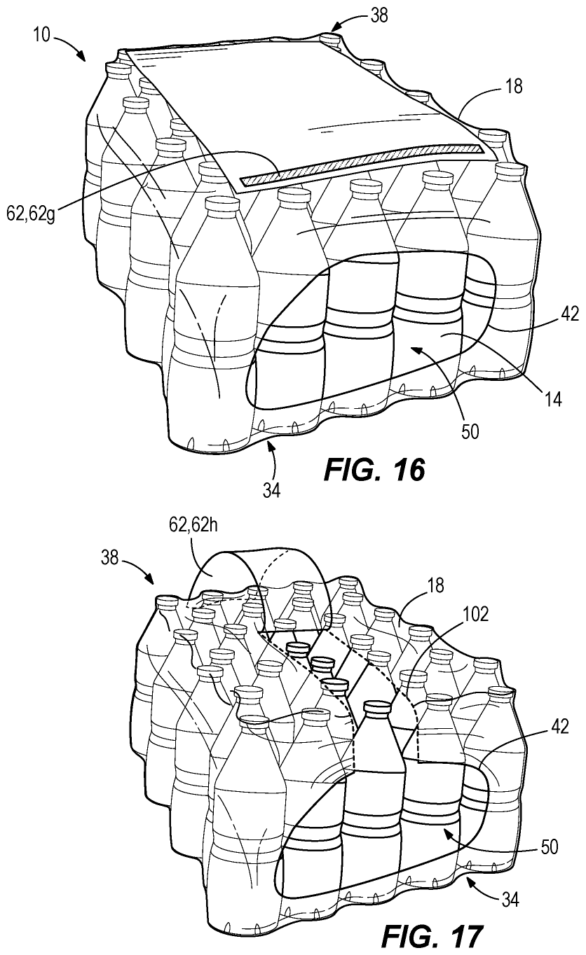

FIG. 16 illustrates another embodiment of the closing component 62 provided as an elongated wire tie fastener or “twist tie” 62g that can be removably adhered to the shrink film 18. The twist tie 62g can be made of one or more metal wires encased in a thin strip of paper or plastic and can retain its shape after bending. In use, the twist tie 62g is removed from the shrink film 18, the first bull's eye 50 is pulled closed by pulling portions of the first rim 42 toward one another, and the twist tie 62g is wrapped about the portions of the first rim 42 to generally close, or reduce an open area of, the first bull's eye 50.

FIG. 17 illustrates another embodiment of the closing component 62 provided as a portion of material or flap 62h formed from the shrink film 18 itself. Specifically, the shrink film 18 can include rows of perforations 102 extending from the first rim 42 of the first bull's eye 50 toward the second bull's eye 54 along a longitudinal direction of the shrink film 18. The shrink film 18 can be torn along the rows of perforations 102 to produce the flap 62h and also enlarge an open area of the first bull's eye 50. The flap 62h can be inserted into the second bull's eye 54 to close the second bull's eye 54, and the spent bottles 14 can be placed back inside the shrink film 18 through the enlarged first bull's eye 54 for storing and transporting. In some embodiments, instead of rows of perforations, lines or other markings can be provided on the shrink film 18 indicating to the user where to cut the shrink film 18 to produce the flap 62h.

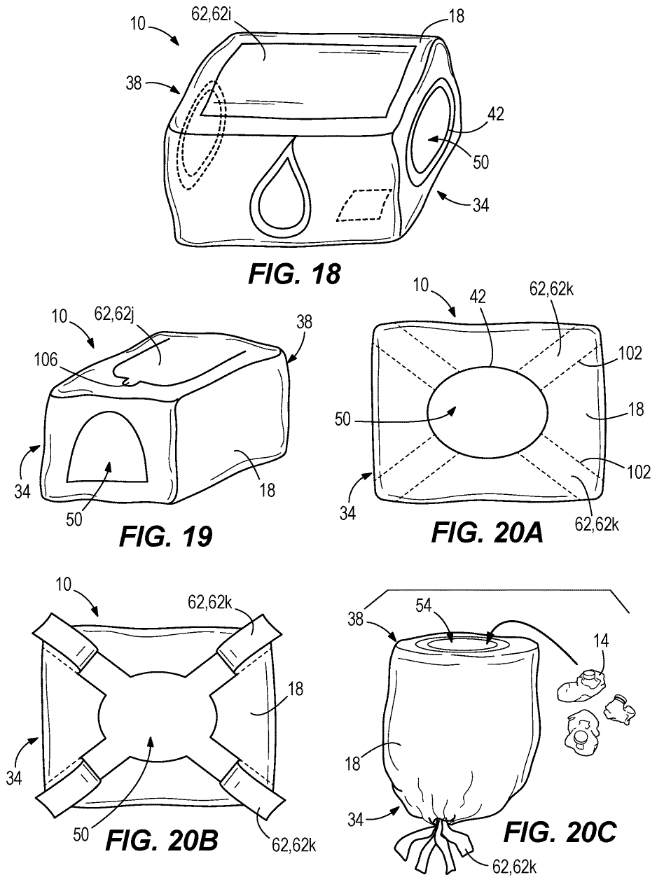

FIG. 18 illustrates another embodiment of the closing component 62 provided as an enlarged, re-adherable sticker 62i coupled to the shrink film 18. The sticker 62i can be peeled away from the shrink film 18, portions of the first rim 42 or portions of the second rim 46 can be pulled under the sticker 62i, and the sticker 62i can be re-adhered to the shrink film 18 to secure the portions of the rims 42, 46 to close the first bull's eye 50 or the second bull's eye 54. Moreover, if the user tears any additional openings in the shrink film 18 during use, the additional openings can likewise be closed with the sticker 62i.

FIG. 19 illustrates another embodiment of the closing component 62 provided as a portion of material or flap 62j formed from the shrink film 18 itself. The flap 62j may be defined by a u-shaped slit that is cut into the shrink film 18 and can include a free end 106 that can removably adhere to a portion of the surrounding shrink film 18 to close the flap 62j. The user can open the flap 62j by pulling the free end 106 away from the shrink film 18 to reveal an opening in the shrink film 18 providing access to the bottles 14. In some embodiments, one or both of the bull's eyes 50, 54 can be omitted so that the shrink film 18 can be repurposed as a bag after the bottles 22 are spent.

FIGS. 20A-20C illustrate another embodiment of the closing component 62 provided as multiple detachable strips 62k formed from the shrink film 18 itself and configured to be tied together to close or reduce an open area of the first bull's eye 50. Specifically, the shrink film 18 can include rows of perforations 102 (FIG. 20A) extending from the first rim 42 of the first bull's eye 50 generally toward the second bull's eye 54 to define the detachable strips 62k, and the shrink film 18 can be torn along the rows of perforations 102 to form the strips 62k (FIG. 20B). In the illustrated embodiment, four pairs of rows of perforations 102 are provided about the first bull's eye 50 to define four detachable strips 62k. In other embodiments, fewer (e.g., two or three) or more (e.g., five, six, or more) strips 62k can be provided, and lines or other markings can be provided on the shrink film 18 in lieu of the perforations to indicate to the user where to cut the shrink film 18 to produce the strips 62k. In use, the strips 62k can be tied together (FIG. 20C) to close the first bull's eye 54 and convert the shrink film 18 to a bag for collecting spent containers 14.

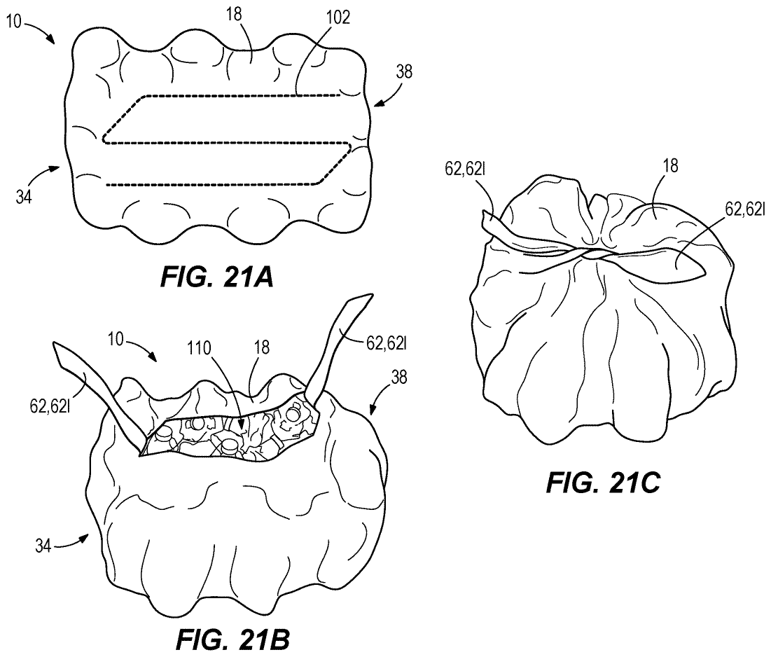

FIGS. 21A-21C illustrate another embodiment of the closing component 62 provided as multiple detachable strips 62l formed from the shrink film 18 itself. Specifically, the shrink film 18 can include a zigzagging row of perforations 102 (FIG. 21A) extending back and forth across a top portion of the shrink film 18. The shrink film 18 can be torn along the row of perforations 102 to produce two of the detachable strips 62l (FIG. 21B) and to create an opening 110 in the top portion of the shrink film 18. In some embodiments, lines or other markings can be provided on the shrink film 18 in lieu of the perforations to indicate to the user where to cut the shrink film 18 to produce the strips 62l. The bottles 14 can be accessed and removed via the opening formed when the strips 621 are created, and then spent bottles 14 can be placed back inside the shrink film 18 and the opening can be closed, or an open area of the opening can be reduced, by tying the strips 62l together (FIG. 21C). In the embodiment of FIGS. 21A-21C one or both of the bull's eyes 50, 54 can be omitted from the shrink film 18.

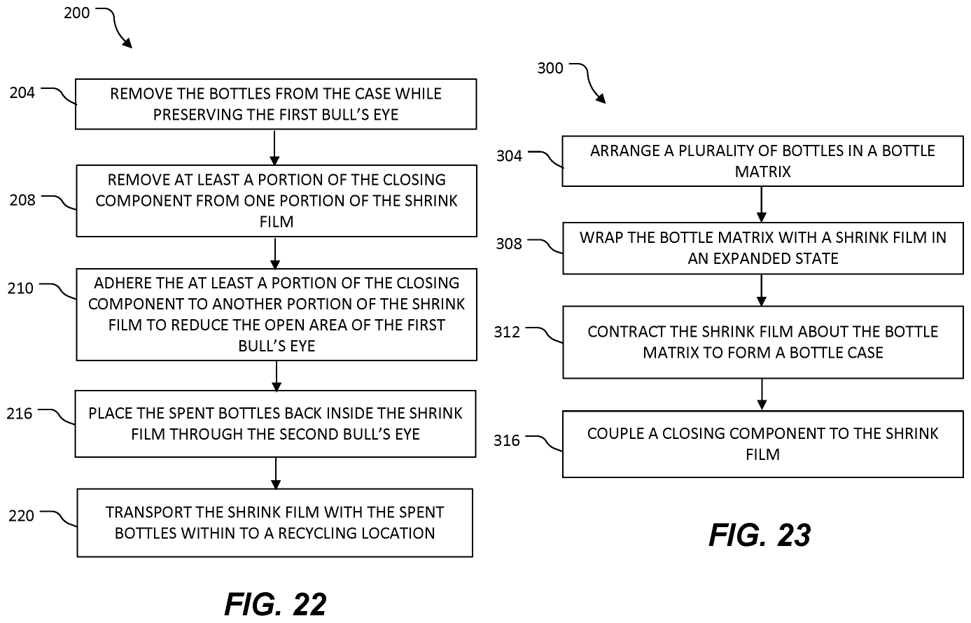

FIG. 22 is a flow chart illustrating a method 200 for recycling the container case 10. First, the unused containers 14 are removed from the shrink film 18 while sufficiently preserving at least one of the bull's eyes 50, 54 (e.g., the first bull's eye 50) (step 204). Excessive tearing or stretching of the first rim 42 of the first bull's eye 50 should be avoided so that the preserved first bull's eye 50 can later be partially or fully closed with the closing component 62. This can be accomplished by, e.g., removing the containers 14 from the shrink film 18 only through the second bull's eye 54 so that the first bull's eye 50 remains undisturbed. Next, at least a portion of the closing component 62 is peeled away or removed from the shrink film 18 (step 208), and then the at least a portion of the closing component 62 is coupled back to the shrink film 18 to reduce the open area of the first bull's eye 50, or at least partially close the first bull's eye 50 (step 212). For example, opposite portions of the first rim 42 can be pinched toward one another, or folded or rolled over one another, and the at least a portion of the closing component 62 can be adhered across the opposite portions of the first rim 42 to partially or fully close the first bull's eye 50. In other examples, the at least a portion of the closing component 62 can be adhered to portions of the first rim 42 or regions of the shrink film in a vicinity of the first rim 42 such that the closing component 62 itself covers or obstructs the open area of the first bull's eye 50. The at least a portion of the closing component 62 can be adhered to the new location on the shrink film 18 while the rest of the closing component can remain adhered to the shrink film 18 at the original location it was provided. In further examples, the entire closing component 62, or an entire portion of the closing component (e.g., a removable top layer of the closing component), can be wholly removed from the shrink film 18 and re-adhered at a new location over the first bull's eye 50 or to regions proximate the first rim 42 to partially or fully close the first bull's eye 50. Next, the used containers 14 (FIG. 4) are placed back inside the converted shrink film 18 through the remaining open second bull's eye 54 (step 216). The converted shrink film 18 filled with the spent containers 14 is then grasped at the second open end 38 adjacent the open second bull's eye 54 and held aloft and transported (step 220). Assembled in this state, the used container case 10 can then easily be carried and transported to a recycling location, and the crushed containers 14 inside are prevented from escaping through the at least partially closed first bull's eye 50.

FIG. 23 is a flow chart illustrating a method 300 for manufacturing the container case 10 including the closing component 62. First the finished containers 14 are positioned into a matrix arrangement such as those described above (step 304), and then a shrink film 18 is wrapped about the containers in an expanded state (step 308). The shrink film 18 is provided in a tubular shape to surround the matrix of containers 14 generally on four continuous sides. Next, the shrink film 18 is contracted about the matrix of containers 14 to tightly wrap the containers 14 to maintain the matrix arrangement (step 312). This can be accomplished by, e.g., heating the shrink film 18 sufficiently to cause the shrink film 18 to contract. Finally, a closing component 62 is coupled to or otherwise affixed to the shrink film 18 (step 316).

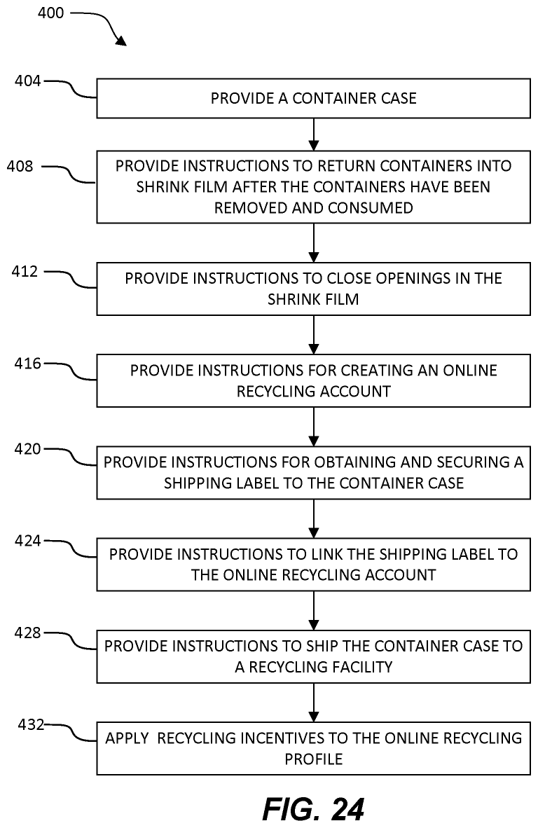

FIG. 24 shows a flow chart illustrating a method 400 of recovering the spent container case 10 from the consumer for recycling by a recycling facility. A first step 404 includes providing a container case such as the container case 10 including containers 14 wrapped in shrink film 18. A second step 408 includes providing instructions to return the containers 14 into the shrink film 18 after the containers 14 have been removed and consumed. Based on the instructions, the consumer places spent containers 14 into the shrink film 18 of the used container case 10 to form a collection. A third step 412 includes providing instructions to close the openings in the shrink film (e.g., bull's eye 50, bull's eye 54, and/or other openings) to secure the containers 14 within the shrink film 18. Based on the instructions, the consumer closes the shrink film 18 to secure the spent containers 14 within for shipping. The container case 10 can be secured by closing any openings in the shrink film 18, such as the first bull's eye 50, the second bull's eye 54, and/or other openings, via the closing component 62 to retain the spent containers 14 within the shrink film 18. In a fourth step 416, instructions are provided for creating an online recycling account. Based on the instructions, the consumer creates an online recycling account that allows the consumer to track the movement of the spent container case 10 in transit to the recycling facility. Furthermore, the online recycling account allows the consumer to receive any recycling incentives and credits from the state and/or the supplier. A fifth step 420 includes providing instructions to obtain a shipping label and visibly secure the shipping label to the used container case 10. In some examples, the shipping label is provided with the container case 10 at the time of purchase. In other examples, the consumer can obtain the label by other means (e.g., printing the label, receiving the label by mail, etc.) before shipping the spent container case 10. The consumer adds or links the shipping label to their online recycling account to monitor the container case 10 during transit and receive any recycling credits available (step 424). A seventh step 428 includes providing instructions to ship the used container case 10 to the recycling facility. Upon receiving the used container case 10 at the recycling facility, any available recycling incentives are applied to the consumer's online recycling profile (step 432). For example, in states with container deposit laws (i.e., “Bottle Bills”), the consumer's refundable deposit on the containers 14, which is paid at the point of purchase, is returned to the consumer via the online recycling account upon receiving the used container case 10 at the recycling facility. The refunded deposit can then be transferred to the customer's bank account. In other examples, product coupons and/or service vouchers can be applied to the online recycling account. The online recycling account allows the consumer to receive recycling incentives electronically rather than physically (i.e., in the form of cash or printed coupons).

At step 408, the consumer can convert the shrink film 18 according to method 200, as described above, to hold the spent containers 14. Specifically, the open area of the first bull's eye 50 can be reduced by removing at least a portion the closing component 62 from the shrink film and coupling the portion of the closing component 62 back to the shrink film 18. Subsequently, the consumer can secure the used container case 10 for shipping by closing at least area of the second bull's eye 54. For example, the second bull's eye 54 can be taped closed. The closing component 62 can be further secured over the first bull's eye 50 with additional securing means, such as tape.

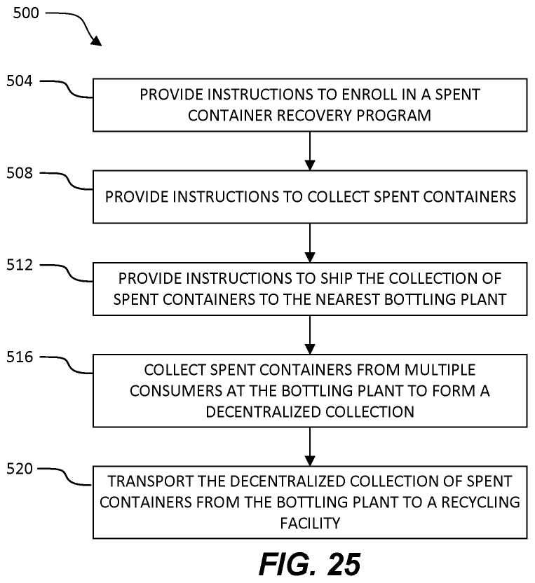

FIG. 25 shows a flow chart illustrating a decentralized method 500 of recovering the spent containers 14 from the consumer for recycling by a recycling facility. The decentralized method 500 includes an intermediate step of receiving the spent containers 14 at a nearest bottling plant for large scale collection before shipping the spent containers 14 to the recycling facility. A first step 504 includes providing instructions to the consumer to enroll in a spent container recovery program. For example, the consumer can form a user account and/or take a membership in the program. Next, the consumer is instructed to collect spent containers 14 and/or used container cases 10 (step 508). The consumer is further instructed to ship the collection of spent containers 14 and/or used container cases 10 to the nearest bottling plant (step 512). For example, the spent containers 14 can be shipped to a PET bottling plant. Spent containers 14 from multiple consumers are collected at the bottling plant until a sufficient number of spent containers 14 are collected (step 516). When a sufficient number of spent containers 14 are collected at the bottling plant, the decentralized collection of spent containers 14 are transported to the recycling facility (step 520), where the spent containers 14 are recycled.

As shown in FIG. 25, the decentralized method 500 can further include intermediate steps of method 200 to convert the used container case 10 to hold the spent containers 14 and method 400 for recovering spent containers 14, as discussed above. In reference to step 508, the area of the first bull's eye 50 is reduced by removing at least a portion the closing component 62 from the shrink film and coupling the portion of the closing component 62 back to the shrink film 18 (as in step 212). The spent containers 14 are collected and then placed into the converted shrink film 18. Step 512 can likewise include providing instructions for obtaining a shipping label and securing the shipping label to the used container case 10 (as in step 416). Recycling incentives can be passed to the consumer upon receipt of the spent containers by the bottling plant or upon receipt at the recycling facility.

Various features of the disclosure are set forth in the following claims.

What is claimed is:

1. A container case comprising:
a plurality of containers wrapped in a shrink film, the shrink film including:
a first open end having a first rim that defines a first opening, and
a second open end located opposite the first open end, the second open end having a second rim that defines a second opening; and
a closing component coupled to the shrink film, the closing component including at least a portion thereof configured for uncoupling from one portion of the shrink film and recoupling to another portion to the shrink film to thereby reduce an area of the first opening, wherein the closing component is in the form of either 1) a sticker removably adhered to the shrink film and having a shape corresponding to a shape of the first opening or 2) a folded sheet including a fixed portion and a movable portion separated by a fold line.

2. The container case of claim 1, wherein a material of the shrink film and the closing component comprises polyethylene.

3. The container case of claim 1, wherein the closing component has an annular shape.

4. A container case comprising:
a plurality of containers wrapped in a shrink film, the shrink film including:
a first open end having a first rim that defines a first opening, and
a second open end located opposite the first open end, the second open end having a second rim that defines a second opening; and
a closing component in the form of a pull string positioned at least partially between two layers of shrink film material, the pull string including two ends protruding from the two layers and configured to be grasped and pulled to thereby reduce an open area of the first opening.

5. A container case comprising:
a plurality of containers wrapped in a shrink film, the shrink film including:
an open end having a rim that defines an opening; and
a closing component in the form of a first portion of the shrink film having a releasable end, the closing component configured to one of 1) adhere to or 2) engage, a second portion of the shrink film to thereby reduce an area of the opening.

6. The container case of claim 5, wherein the closing component is integrally formed as one piece with the shrink film.

7. The container case of claim 5, wherein the releasable end is defined by a slit cut into the shrink film.

8. The container case of claim 5, wherein the closing component is configured to permit access to the plurality of containers.

9. The container case of claim 5, wherein the second portion includes the rim.

10. The container case of claim 5, wherein the releasable end is a first releasable end, and wherein the second portion includes a second releasable end configured to engage the first releasable end to thereby reduce an area of the opening.

11. The container case of claim 10, wherein the second releasable end is configured to be tied to the first releasable end to thereby reduce an area of the opening.

12. The container of claim 10, wherein the first releasable end and the second releasable end are detachable via perforations of the respective first and second portions.

13. The container of claim 10, wherein a border of the first releasable end and of the second releasable end is defined by the rim.

14. The container of claim 12, wherein a border of the first releasable end and of the second releasable end is defined by the rim.

15. The container of claim 5, wherein the first portion includes markings thereon defining the releasable end.

16. The container of claim 5, wherein the closing component is configured to at least one of 1) adhere to and 2) engage, the second portion.

17. The container of claim 5, wherein the open end is a first open end, the rim is a first rim, and the opening is a first opening, and wherein the container case further includes a second open end located opposite the first open end, the second open end having a second rim that defines a second opening.
